(19) United States
(12) Patent Application Publication
(10) Pub. No.: US 2006/0120448 A1
(43) Pub. Date: Jun. 8, 2006

(54) Method and apparatus for encoding/decoding multi-layer video using DCT upsampling

(75) Inventors: Woo-jin Han, Suwon-si (KR); Sang-chang Cha, Hwaseong-si (KR); Ho-jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/288,210

(22) Filed: Nov. 29, 2005

Related U.S. Application Data
(60) Provisional application No. 60/632,604, filed on Dec. 3, 2004.

(30) Foreign Application Priority Data
Jan. 25, 2005 (KR) 10-2005-0006810

(51) Int. Cl. H04N 11/04; H04N 7/12; H04B 1/66; H04N 11/02

(52) U.S. Cl. 375/240.2; 375/240.24; 375/240.12; 375/240.03; 375/240.08

(57) ABSTRACT

A method and apparatus for more efficiently upsampling a base layer to perform interlayer prediction during multi-layer video coding are provided. The method includes encoding and reconstructing a base layer frame, performing discrete cosine transform (DCT) upsampling on a second block of a predetermined size in the reconstructed frame corresponding to a first block in an enhancement layer frame, calculating a difference between the first block and a third block generated by the DCT upsampling, and encoding the difference.

### CROSS-REFERENCE TO RELATED APPLICATIONS

This application claims priority from Korean Patent Application No. 10-2005-0006810 filed on Jan. 25, 2005 in the Korean Intellectual Property Office, and U.S. Provisional Patent Application No. 60/632,604 filed on Dec. 3, 2004 in the United States Patent and Trademark Office, the disclosures of which are incorporated herein by reference in their entirety.

### BACKGROUND OF THE INVENTION

1. Field of the Invention

Apparatuses and methods consistent with the present invention relate to video compression, and more particularly, to more efficiently upsampling a base layer to perform interlayer prediction during multi-layer video coding.

2. Description of the Related Art

With the development of information communication technology, including the Internet, video communication as well as text and voice communication, has increased dramatically. Conventional text communication cannot satisfy various user demands, and thus, multimedia services that can provide various types of information such as text, pictures, and music have increased. However, multimedia data requires storage media that have a large capacity and a wide bandwidth for transmission since the amount of multimedia data is usually large. Accordingly, a compression coding method is required for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy which takes into account human eyesight and its limited perception of high frequency. In general video coding, temporal redundancy is removed by temporal filtering based on motion compensation, and spatial redundancy is removed by spatial transformation.

To transmit multimedia generated after removing data redundancy, transmission media are required. Different types of transmission media for multimedia have different performance. Currently used transmission media have various transmission rates. For example, an ultrahigh-speed communication network can transmit data of several tens of megabits per second while a mobile communication network has a transmission rate of 384 kilobits per second. To support transmission media having various speeds or to transmit multimedia, data coding methods having scalability may be suitable to a multimedia environment.

Scalability indicates the ability to partially decode a single compressed bitstream. Scalability includes spatial scalability indicating a video resolution, signal-to-noise ratio (SNR) scalability indicating a video quality level, and temporal scalability indicating a frame rate.

Moving Picture Experts Group (MPEG)-21 PART-13 standardization for scalable video coding is under way. In particular, a multi-layered video coding method is widely recognized as a promising technique. For example, a bitstream may consist of multiple layers, i.e., a base layer, enhanced layer 1, and enhanced layer 2 with different resolutions (QCIF, CIF, and 2CIF) or frame rates.

FIG. 1 shows an example of a scalable video codec using a multi-layer structure. Referring to FIG. 1, a base layer has a Quarter Common Intermediate Format (QCIF) resolution and a frame rate of 15 Hz, a first enhancement layer has a Common Intermediate Format (CIF) resolution and a frame rate of 30 Hz, and a second enhancement layer has a Standard Definition (SD) resolution and a frame rate of 60 Hz.

Interlayer correlation may be used in encoding a multi-layer video frame. For example, a region 12 in a first enhancement layer video frame may be efficiently encoded using prediction from a corresponding region 13 in a base layer video frame. Similarly, a region 11 in a second enhancement layer video frame can be efficiently encoded using prediction from the region 12 in the first enhancement layer.

When each layer of a multi-layer video has a different resolution, an image of the region 13 of the base layer needs to be upsampled before the prediction is performed.

FIG. 2 illustrates a conventional upsampling process for predicting an enhancement layer from a base layer. Referring to FIG. 2, a current block 40 in an enhancement layer frame 20 corresponds to a predetermined block 30 in a base layer frame 10. In this case, because the resolution CIF of the enhancement layer is twice the resolution QCIF of the base layer, the block 30 in the base layer frame 10 is upsampled to twice its resolution. Conventionally, half-pel interpolation or bi-linear interpolation provided by H.264 is used for upsampling. The conventional upsampling technique may offer good visual quality when being used to magnify an image for detailed observation because it smoothes the quality of an image.

However, when being used to predict an enhancement layer, this technique may cause a mismatch between a discrete cosine transform (DCT) block 37 generated by performing DCT on an upsampled block 35 and a DCT block 45 generated by performing DCT on the current block 40. That is, since upsampling followed by DCT results in loss of partial information in the DCT block 37 due to failure to reconstruct a low-pass component of the original block 30, the conventional upsampling technique may be inefficient for use in an H.264 or MPEG-4 codec utilizing DCT for spatial transform.

### SUMMARY OF THE INVENTION

The present invention provides a method for preserving the low-pass component of a base layer region as much as possible when the base layer region is upsampled to predict an enhancement layer.

The present invention also provides a method for reducing a mismatch between the result of performing DCT and the result of upsampling a base layer when the DCT is used to perform spatial transform on an enhancement layer.

According to an aspect of the present invention, there is provided a method for encoding a multi-layer video including the operations of: encoding and reconstructing a base layer frame, performing DCT upsampling on a second block of a predetermined size in the reconstructed frame corresponding to a first block in an enhancement layer frame, calculating a difference between the first block and a third block generated by the DCT upsampling, and encoding the difference.

According to another aspect of the present invention, there is provided a method for encoding a multi-layer video including reconstructing a base layer residual frame from an encoded base layer frame, performing DCT upsampling on a second block of a predetermined size in the reconstructed base layer residual frame corresponding to a first residual block in an enhancement layer residual frame, calculating a difference between the first residual block and a third block generated by the DCT upsampling, and encoding the difference.

According to still another aspect of the present invention, there is provided a method for encoding a multi-layer video including encoding and inversely quantizing a base layer frame, performing DCT upsampling on a second block of a predetermined size in the inversely quantized frame corresponding to a first block in an enhancement layer frame, calculating a difference between the first block and a third block generated by the DCT upsampling, and encoding the difference.

According to yet another aspect of the present invention, there is provided a method for decoding a multi-layer video including reconstructing a base layer frame from a base layer bitstream, reconstructing a difference frame from an enhancement layer bitstream, performing DCT upsampling on a second block of a predetermined size in the reconstructed base layer frame corresponding to a first block in the difference frame, and adding a third block generated by the DCT upsampling to the first block.

According to a further aspect of the present invention, there is provided a method for decoding a multi-layer video including reconstructing a base layer frame from a base layer bitstream, reconstructing a difference frame from an enhancement layer bitstream, performing DCT upsampling on a second block of a predetermined size in the reconstructed base layer frame corresponding to a first block in the difference frame, adding a third block generated by the DCT upsampling to the first block, and adding a fourth block generated by adding the third block to the first block to a block in a motion-compensated frame corresponding to the fourth block.

According to a still further aspect of the present invention, there is provided a method for decoding a multi-layer video including extracting texture data from a base layer bitstream and inversely quantizing the extracted texture data, reconstructing a difference frame from an enhancement layer bitstream, performing Discrete Cosine Transform (DCT) upsampling on a second block of a predetermined size in the inversely quantized result corresponding to a first block in the difference frame, and adding a third block generated by the DCT upsampling to the first block.

According to yet a further aspect of the present invention, there is provided a multi-layered video encoder including means for encoding and reconstructing a base layer frame, means for performing Discrete Cosine Transform (DCT) upsampling on a second block of a predetermined size in the reconstructed frame corresponding to a first block in an enhancement layer frame, means for calculating a difference between the first block and a third block generated by the DCT upsampling, and means for encoding the difference.

According to still yet another aspect of the present invention, there is provided a multi-layered video decoder including means for reconstructing a base layer frame from a base layer bitstream, means for reconstructing a difference frame from an enhancement layer bitstream, means for performing Discrete Cosine Transform (DCT) upsampling on a second block of a predetermined size in the reconstructed base layer frame corresponding to a first block in the difference frame, and means for adding a third block generated by the DCT upsampling to the first block.

### BRIEF DESCRIPTION OF THE DRAWINGS

The above and other aspects of the present invention will become more apparent by describing in detail exemplary embodiments thereof with reference to the attached drawings in which:

FIG. 1 shows an example of a typical scalable video codec using a multi-layer structure;

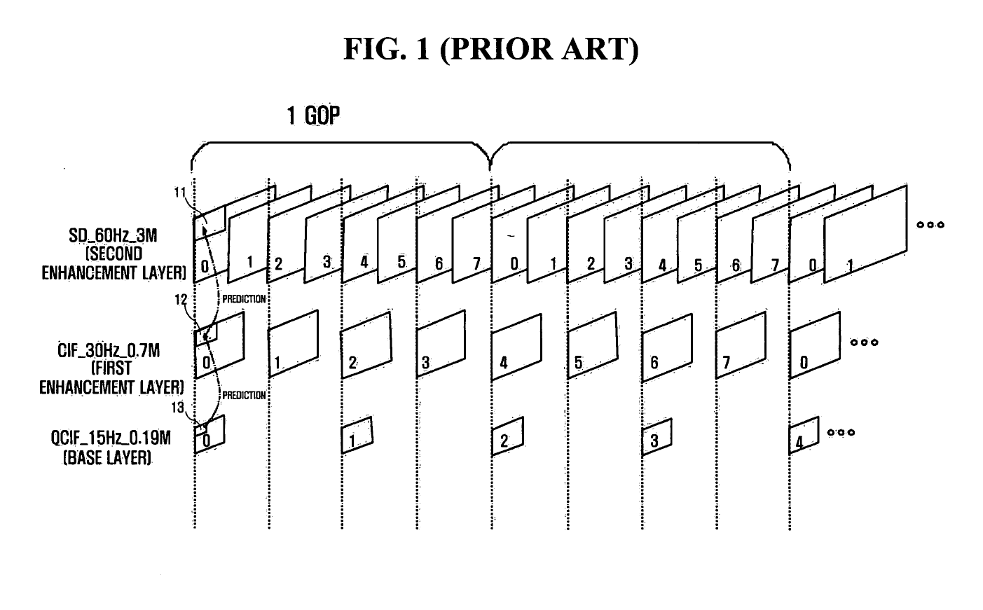

FIG. 2 shows a conventional upsampling process used for predicting an enhancement layer from a base layer;

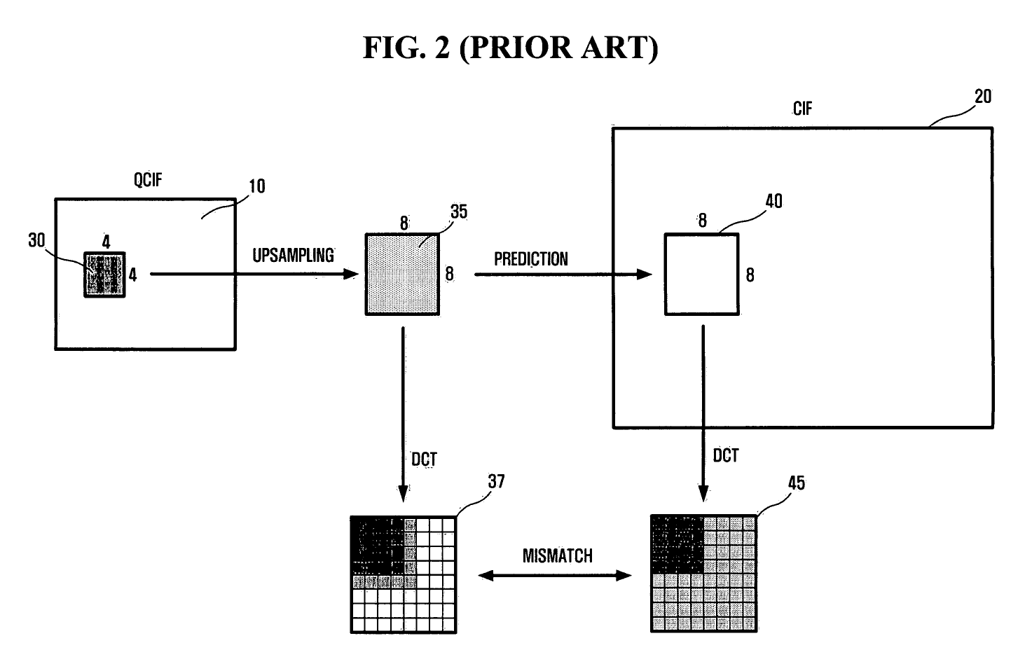

FIG. 3 schematically shows a Discrete Cosine Transform (DCT) upsampling process used in the present invention;

FIG. 4 shows an example of a zero-padding process;

FIG. 5 shows an example of performing interlayer prediction for each hierarchical variable-size motion block;

FIG. 6 is a block diagram of a video encoder according to a first exemplary embodiment of the present invention;

FIG. 7 is a block diagram of a DCT upsampler according to an exemplary embodiment of the present invention;

FIG. 8 is a block diagram of a video encoder according to a second exemplary embodiment of the present invention;

FIG. 9 is a block diagram of a video encoder according to a third exemplary embodiment of the present invention;

FIG. 10 is a block diagram of a video decoder corresponding to the video encoder of FIG. 6;

FIG. 11 is a block diagram of a video decoder corresponding to the video encoder of FIG. 8; and

FIG. 12 is a block diagram of a video decoder corresponding to the video encoder of FIG. 9.

### DETAILED DESCRIPTION OF EXEMPLARY EMBODIMENTS OF THE INVENTION

The present invention will now be described more fully with reference to the accompanying drawings, in which exemplary embodiments of the invention are shown.

The present invention will now be described more fully with reference to the accompanying drawings, in which exemplary embodiments of this invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

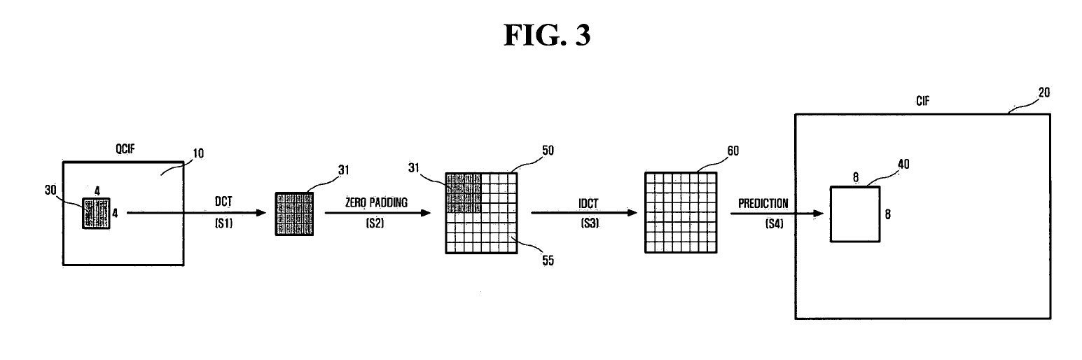

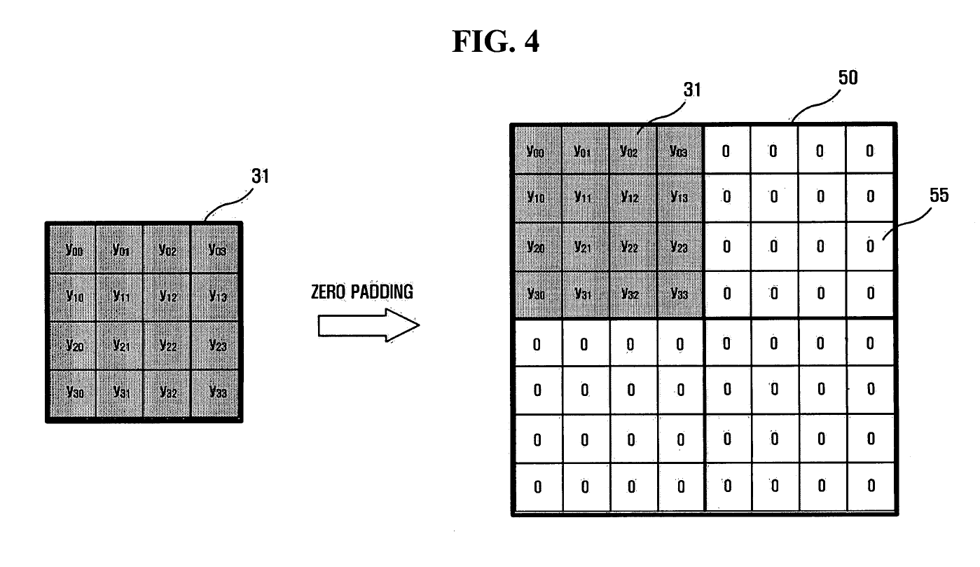

FIG. 3 schematically shows a DCT upsampling process used in the present invention. Referring to FIG. 3, in operation S1, Discrete Cosine Transform (DCT) is performed on a block 30 in a base layer frame 10 to generate a DCT block 31. In operation S2, zero-padding is added to the DCT block 31 to generate a block 50 enlarged to that of a current block 40 in an enhancement layer frame 20. As shown in FIG. 4, the zero-padding is the process of filling the upper left corner of the block 50 whose size is enlarged by the ratio of the resolution of an enhancement layer to the resolution of a base layer with DCT coefficients y₀₀ through y₃₃ of the block 30 while filling the remaining region 95 with zeros.

Next, an inverse DCT (IDCT) is performed on the enlarged block 50 according to a predetermined transform size to generate a predicted block 60 in operation S3 and predict the current block 40 using the predicted block 60 in operation S4 (hereinafter referred to as ‘interlayer prediction’). The DCT performed in the operation S1 has a different transform size than the IDCT performed in the operation S3. That is, when a base layer block 30 has a size of 4×4 pixels, the DCT is 4×4 DCT. When the size of the block 50 produced in the operation S2 is double the size of the base layer block 30, the IDCT has a 8×8 transform size.

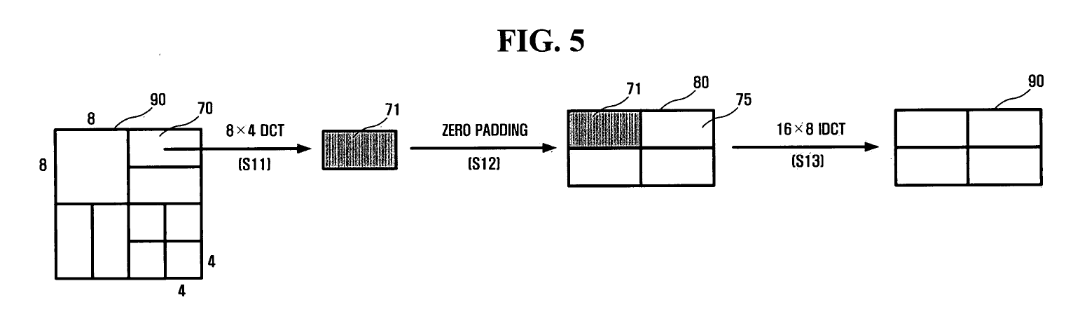

The present invention includes an example of performing interlayer prediction for each DCT block in a base layer as shown in FIG. 3 as well as an example of performing interlayer prediction for each hierarchical variable-size motion block used in motion estimation for H.264 as shown in FIG. 5. Of course, the interlayer prediction may also be performed for each fixed-size motion block. A block for which motion estimation for calculating a motion vector is performed is hereinafter referred to as a “motion block,” regardless of whether the block is of variable or fixed size.

In H.264, a macroblock 90 is segmented into optimum motion block modes and motion estimation and motion compensation are performed for each motion block. According to the present invention, DCT transform (operation S11), zero padding (operation S12), and IDCT transform (operation S13) are sequentially performed for each of motion blocks of various sizes to generate a predicted block and predict a current block using the predicted block.

Referring to FIG. 5, when the motion block is an 8×4 block 70, in operation S11, 8×4 DCT is performed on the block 70 to generate a DCT block 71. In operation S12, zero padding is added to the DCT block 71 to generate a block 80 of a size enlarged to the size of 16×8. In operation S13, 16×8 IDCT is performed on the block 80 to generate a predicted block 90. Then, the predicted block 90 is used to predict a current block.

The present invention proposes three exemplary approaches to performing upsampling for predicting a current block. In a first exemplary embodiment, a predetermined block in a reconstructed base layer video frame is upsampled and the upsampled block is used to predict a current block in an enhancement layer. In a second exemplary embodiment, a predetermined block in a reconstructed temporal base layer residual frame (“residual frame”) is upsampled and the upsampled block is used for predicting a temporal current enhancement layer block (“residual block”). In a third exemplary embodiment, an upsampling is performed on the result of performing DCT on a block in a base layer frame.

To clarify the terms used herein, a residual frame is defined as a difference between frames at different positions in the same layer while a difference frame is defined as a difference between a current layer frame and a lower layer frame at the same temporal position when interlayer prediction is used. Given these definitions, a block in a residual frame can be called a residual block while a block in a difference frame can be called a difference block.

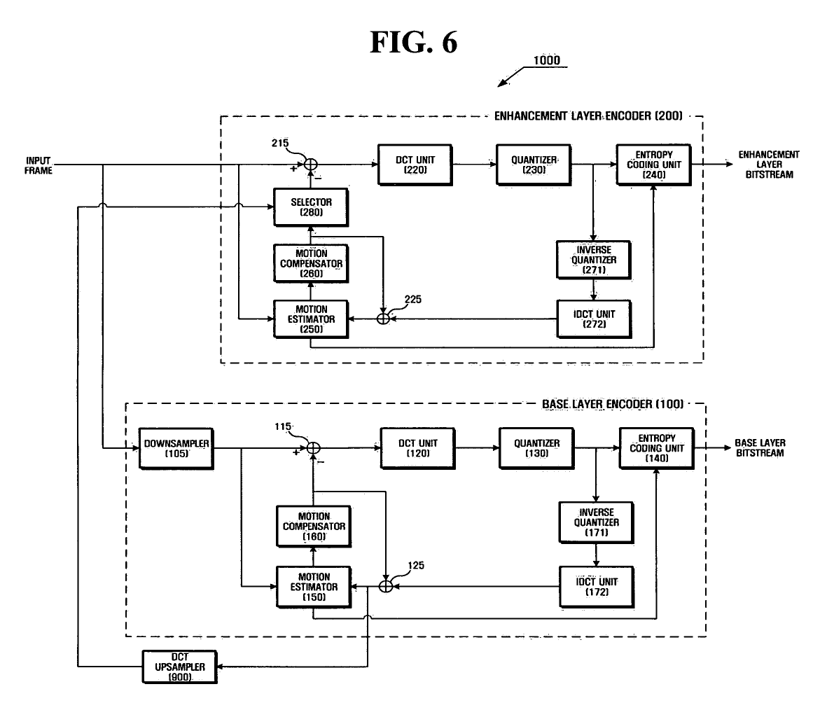

FIG. 6 is a block diagram of a video encoder 1000 according to a first exemplary embodiment of the present invention. Referring to FIG. 6, the video encoder 1000 includes a DCT upsampler 900, an enhancement layer encoder 200, and a base layer encoder 100.

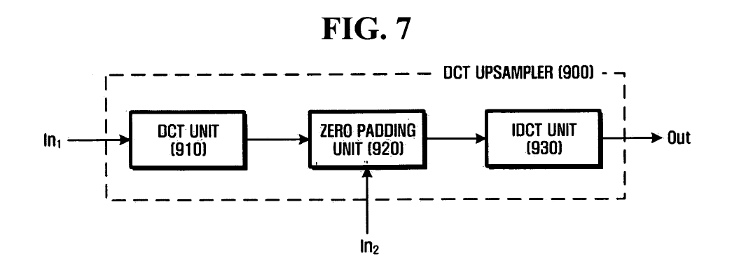

FIG. 7 shows the configuration of the DCT upsampler 900 according to an exemplary embodiment of the present invention. Referring to FIG. 7, the DCT upsampler 900 includes a DCT unit 910, a zero padding unit 920, and an IDCT unit 930. While FIG. 7 shows first and second inputs In₁ and In₂, only the first input In₁ is used in the first exemplary embodiment.

The DCT unit 910 receives an image of a block of a predetermined size in a video frame reconstructed by the base layer encoder 100 and performs DCT of the predetermined size (e.g., 4×4). The predetermined block size may be equal to the transform size of the DCT unit 120. The predetermined block size may be equal to the size of a motion block considering matching to the motion block. For example, in H.264, a motion block may have a block size of 16×16, 16×8, 8×16, 8×8, 8×4, 4×8, or 4×4.

The zero padding unit 920 fills the upper left corner of a block enlarged by the ratio (e.g., twice) of the resolution of an enhancement layer to the resolution of a base layer with DCT coefficients generated by the DCT while padding zeros to the remaining region of the enlarged block.

Lastly, the IDCT unit 930 performs IDCT on a block generated by the zero padding according to a transform size equal to the size of the block (e.g., 8×8). The inversely DCT-transformed result is then provided to the enhancement layer encoder 200. The configuration of the enhancement layer encoder 200 will now be described.

A selector 280 selects one of a signal received from the DCT upsampler 900 and a signal received from a motion compensator 260 and outputs the selected signal. The selection is performed by selecting a more efficient one of interlayer prediction and temporal prediction.

A motion estimator 250 performs motion estimation on a current frame among input video frames using a reference frame to obtain motion vectors. In several algorithms for motion estimation, a block matching algorithm (BMA) is most frequently used. That is, the BMA is a method of estimating a displacement, in which an error is minimum, as a motion vector while moving over a given block in units of pixels within a specific search region of a reference frame. Motion estimation may be performed using not only a fixed motion block size but also a variable motion block size based on a hierarchical search block matching algorithm (HSBMA). The motion estimator 250 provides motion data, including the motion vector obtained by motion estimation, a motion block mode, a reference frame number, and so on, to an entropy coding unit 240.

A motion compensator 260 performs motion compensation on a reference frame using the motion vectors calculated by the motion estimator 250 and generates a temporally predicted frame for the current frame.

A subtractor 215 subtracts the signal selected by the selector 280 from a current input frame signal in order to remove temporal redundancy within the current input frame.

The DCT unit 220 performs DCT of a predetermined size on the frame in which the temporal redundancy has been removed by the subtractor 215 and creates DCT coefficients that will be defined by Equation (1):

$${Y}_{xy} = {C}_{x} {C}_{y} {\sum }_{i = 0}^{M - 1} {\sum }_{j = 0}^{N - 1} {X}_{ij} cos \frac{( 2 j + 1 ) y π}{2 N} cos \frac{( 2 i + 1 ) x π}{2 M} \\ {C}_{x} = \sqrt{\frac{1}{M}} ( k = 0 ) , \sqrt{\frac{2}{M}} ( k > 0 ) \\ {C}_{y} = \sqrt{\frac{1}{N}} ( k = 0 ) , \sqrt{\frac{2}{N}} ( k > 0 ) \qquad ( 1 )$$

where Y_{xy} is a coefficient generated by DCT (“DCT coefficient”), Xᵢⱼ is a pixel value for a block input to the DCT unit 120, and M and N denote horizontal and vertical DCT transform size (M×N). For 8×8 DCT, M=8 and N=8.

The transform size of the DCT unit 220 may be equal to or different from that in the IDCT performed by the DCT upsampler 900.

The quantizer 230 performs quantization on the DCT coefficient to produce a quantization coefficient. Here, quantization is a methodology to express the transformation coefficient expressed in an arbitrary real number as a finite number of bits. Known quantization techniques include scalar quantization, vector quantization, and the like. However, the present invention will be described with respect to scalar quantization by way of example.

In scalar quantization, a coefficient Q_{xy} produced by quantization (“quantization coefficient”’) is defined by Equation (2):

$${Q}_{xy} = round ( \frac{{Y}_{xy}}{{S}_{xy}} ) \qquad ( 2 )$$

where round (.) and S_{xy} denote a function rounding to the nearest integer and a operation size, respectively. The operation size is determined by a M×N quantization table defined by JPEG, MPEG, or other standards.

Here, x=0, . . . , and M−1 and y=0, . . . , and N−1.

The entropy coding unit 240 losslessly encodes the quantization coefficients generated by the quantizer 230 and the motion data provided by the motion estimator 250 into an output bitstream. Examples of the lossless encoding include arithmetic coding, variable length coding, and so on.

To support closed-loop encoding in order to reduce a drifting error caused due to a mismatch between an encoder and a decoder, the video encoder 1000 further includes an inverse quantizer 271 and an IDCT unit 272.

The inverse quantizer 271 performs inverse quantization on the coefficient quantized by the quantizer 232. The inverse quantization is the inverse of quantization. The IDCT unit 272 performs IDCT on the inversely quantized result and transmits the result to an adder 225.

The adder 225 adds the inversely DCT-transformed result provided by the IDCT unit 172 to the previous frame provided by the motion compensator 260 and stored in a frame buffer (not shown) to reconstruct a video frame and transmits the reconstructed video frame to the motion estimator as a reference frame.

Meanwhile, the base layer encoder 100 includes a DCT unit 120, a quantizer 130, an entropy coding unit 140, a motion estimator 150, a motion compensator 160, an inverse quantizer 171, an IDCT unit 172, and a downsampler 105.

A downsampler 105 downsamples an original input frame to the resolution of the base layer. While various techniques can be used for the downsampling, the downsampler 105 may be a DCT downsampler that is matched to the DCT upsampler 900. The DCT downsampler performs DCT on an input image block, followed by IDCT on DCT coefficients in the upper left corner of the block, thereby reducing the scale of the image block to one half.

Because elements in the base layer encoder 100 other than the downsampler 105 perform the same operations as those of their counterparts in the enhancement layer encoder 200, a detailed explanation thereof will not be given.

Meanwhile, upsampling for interlayer prediction according to the present invention may apply to a full image as well as a residual image. That is, interlayer prediction may be performed between an enhancement layer residual image generated using temporal prediction and a corresponding base layer residual image. In this case, a predetermined block in a base layer needs to be upsampled before being used for predicting a current block in an enhancement layer.

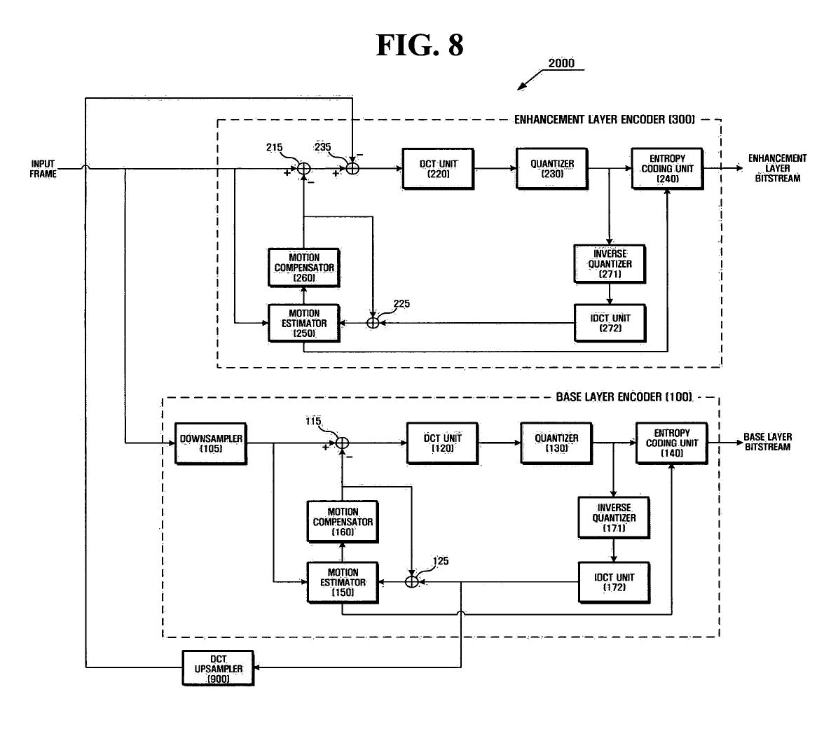

FIG. 8 is a block diagram of a video encoder 2000 according to a second exemplary embodiment of the present invention. In the second exemplary embodiment, a DCT upsampler 900 receives a reconstructed base layer residual frame as an input instead of a reconstructed base layer video frame. Thus, a signal (reconstructed residual frame signal) obtained before passing through an adder 125 of a base layer encoder 100 is fed into the DCT upsampler 900. Like in the first exemplary embodiment, the first input In₁ shown in FIG. 7 is used in the second exemplary embodiment.

The DCT upsampler 900 receives an image of a block of a predetermined size in a residual frame reconstructed by the base layer encoder 100 to perform DCT, zero padding, and IDCT as shown in FIG. 7. A signal upsampled by the DCT upsampler 900 is fed into a second subtractor 235 of an enhancement layer encoder 300.

The configuration of the enhancement layer encoder 300 will now be described focusing on the difference from the enhancement layer encoder 200 of FIG. 6. A predicted frame provided by the motion compensator 260 is fed into a first subtractor 215 that then subtract the predicted frame signal from a current input frame signal to generate a residual frame.

The second subtractor 235 subtracts an upsampled block output from the DCT upsampler 900 from a corresponding block in the residual frame and transmits the result to a DCT unit 220.

Because the remaining elements in the enhancement layer encoder 300 perform the same operations as their counterparts in the enhancement layer encoder 200 of FIG. 6, a detailed explanation thereof will not be given. Elements in the base layer encoder 100 also perform the same operations as their counterparts in the base layer encoder 100 except that a signal obtained before passing through an adder 125 of a base layer encoder 100, that is, after passing through an IDCT unit 172, is fed into the DCT upsampler 900.

Meanwhile, when the DCT upsampler 900 uses the DCT-transformed result obtained by the base layer encoder 10 to perform upsampling according to a third exemplary embodiment of the present invention, a DCT process may be skipped. In this case, a signal inversely quantized by the base layer encoder 100 is subjected to IDCT without being subjected to temporal prediction to reconstruct a video frame.

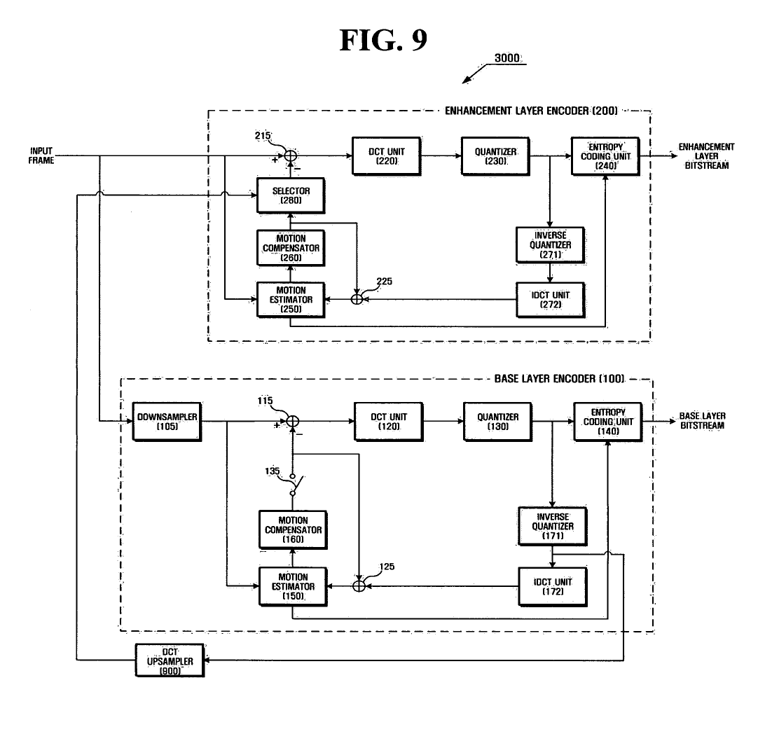

FIG. 9 is a block diagram of a video encoder 3000 according to a third exemplary embodiment of the present invention. Referring to FIG. 9, the output of an inverse quantizer 171 for a frame that has not undergone temporal prediction is fed into the DCT upsampler 900.

A switch 135 disconnects or connects signal passing from a motion compensator 160 to a subtractor 115. While the switch 135 blocks the signal to pass from the motion compensator 160 to a subtractor 115 when temporal prediction applies to a current frame, it allows the signal to pass from the motion compensator 160 to a subtractor 115 when temporal prediction does not apply to the current frame.

The third exemplary embodiment of the present invention is applied to a frame encoded without being subjected to temporal prediction when the switch 135 blocks the signal in a base layer. In this case, an input frame is subjected to downsampling, DCT, quantization, and inverse quantization by a downsampler 105, a DCT unit 120, a quantizer 130, and an inverse quantizer 171, respectively, before being fed into the DCT upsampler 900.

The DCT upsampler 900 receives coefficients of a predetermined block in a frame subjected to the inverse quantization as input In₂ (see FIG. 7). The zero padding unit 920 fills the upper left corner of the block whose size is enlarged by the ratio of the resolution of the enhancement layer to the resolution of the base layer with coefficients of a predetermined block while filling the remaining region of the enlarged block with zeros.

The IDCT unit 930 performs IDCT on the enlarged block generated using the zero padding according to the transform size that is equal to the size of the enlarged block. The inversely DCT-transformed result is then provided to a selector 280 of the enhancement layer encoder 200. For subsequent operations, the enhancement layer encoder 200 performs the same processes as its counterpart shown in FIG. 6, so a detailed explanation thereof will be omitted.

The upsampling process in the third exemplary embodiment of the present invention is efficient because of the use of the DCT-transformed result obtained by the base layer encoder 100.

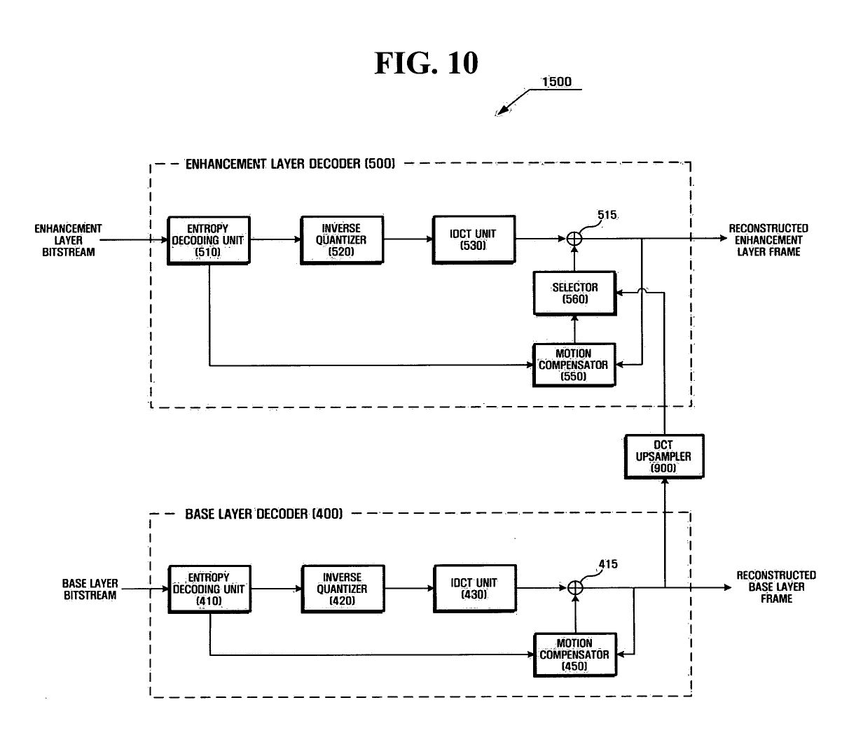

FIG. 10 is a block diagram of a video decoder 1500 corresponding to the video encoder 1000 of FIG. 6. Referring to FIG. 10, the video decoder 1500 mainly includes a DCT upsampler 900, an enhancement layer decoder 500, and a base layer decoder 400.

The DCT upsampler 900 has the same configuration as shown in FIG. 7 and receives a base layer frame reconstructed by the base layer decoder 400 as an input In₁. A DCT unit 910 receives an image of a block of a predetermined size in the base layer frame and performs DCT of the predetermined size. The predetermined block size may be equal to the transform size of the DCT unit 120 in the DCT upsampler 900 of the video encoder 1000. A decoding process performed by the video decoder 1500 is matched to the encoding process performed by the video encoder 1000 in this way, thereby reducing a drifting error that may occur due to a mismatch between an encoder and a decoder. The predetermined block size may be equal to the size of a motion block considering matching to the motion block.

A zero padding unit 920 fills the upper left corner of a block enlarged by the ratio of the resolution of an enhancement layer to the resolution of a base layer with DCT coefficients generated by the DCT while padding zeros to the remaining region of the enlarged block. An IDCT unit 930 performs IDCT on a block generated using the zero padding according to a transform size equal to the size of the block. The inversely DCT-transformed result, i.e., the DCT-upsampled result is then provided to a selector 560.

Next, the enhancement layer decoder 500 includes an entropy decoding unit 510, an inverse quantizer 520, an IDCT unit 530, a motion compensator 550, and a selector 560. The entropy decoding unit 510 performs lossless decoding that is the inverse of entropy encoding to extract texture data and motion data that are then fed to the inverse quantizer 520 and the motion compensator 550, respectively.

The inverse quantizer 520 performs inverse quantization on the texture data received from the entropy decoding unit 510 using the same quantization table that used in the video encoder 1000.

A coefficient generated by inverse quantization is calculated using Equation (3) below. Here, the coefficient Y_{xy}′ is different from Y_{xy} calculated using the Equation (1) because lossy encoding employing a round (.) function is used in the Equation (1).
Y′_{xy}=Q_{xy}×S_{xy} (3)

Next, the IDCT unit 530 performs IDCT on the coefficient Y_{xy}′ obtained by the inverse quantization. The inversely DCT-transformed result Xᵢⱼ′ is calculated using Equation (4):

$${X}_{ij}^{′} = {\sum }_{x = 0}^{M - 1} {\sum }_{y = 0}^{N - 1} {C}_{x} {C}_{y} {Y}_{xy}^{′} cos \frac{( 2 j + 1 ) y π}{2 N} cos \frac{( 2 i + 1 ) x π}{2 M} \qquad ( 4 )$$

After the IDCT, a difference frame or a residual frame is reconstructed.

The motion compensator 550 performs motion compensation on a previously reconstructed video frame using the motion data received from the entropy decoding unit 510, generates a motion-compensated frame, and the generated frame signal is transmitted to the selector 560.

The selector 560 selects one of the signal received from the DCT upsampler 900 and the signal received from the motion compensator 550 and outputs the selected signal to an adder 515. When the inversely DCT-transformed result is a difference frame, the signal received from the DCT upsampler 900 is output. On the other hand, when the inversely DCT-transformed result is a residual frame, the signal received from the motion compensator 550 is output.

The adder 515 adds the signal chosen by the selector 560 to the signal output from the IDCT unit 530, thereby reconstructing an enhancement layer video frame.

Because elements in the base layer decoder 400 perform the same operations as those of their counterparts in the enhancement layer decoder 500 except that the base layer decoder 400 does not include the selector 560, a detailed explanation thereof will not be given.

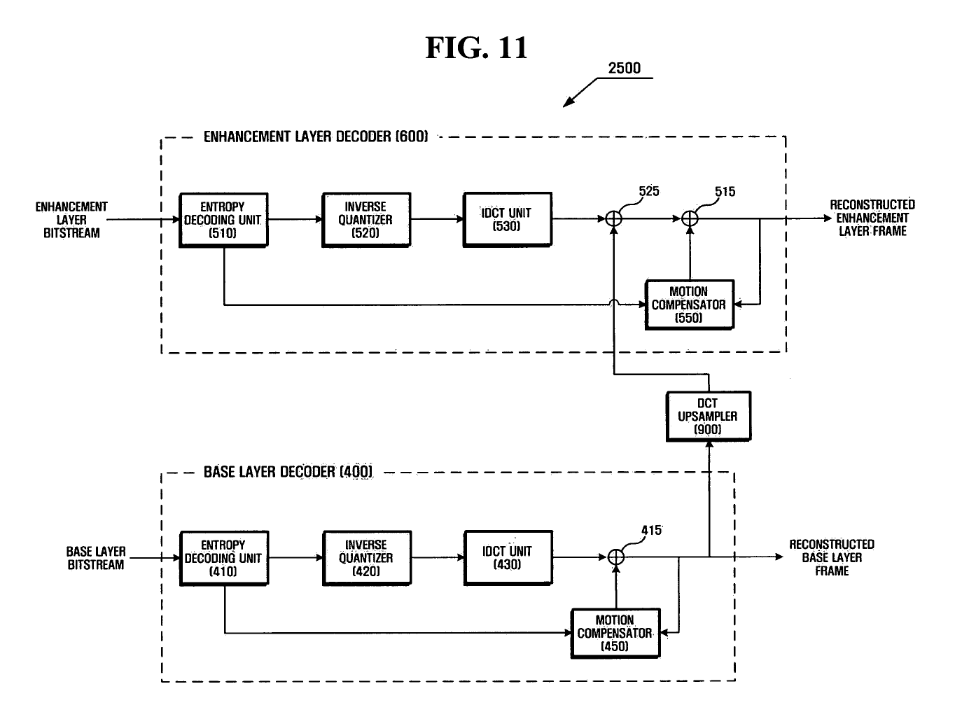

FIG. 11 is a block diagram of a video decoder 2500 corresponding to the video encoder 2000 of FIG. 8. Referring to FIG. 11, the video decoder 2500 mainly includes a DCT upsampler 900, an enhancement layer decoder 600, and a base layer decoder 400.

Like in the video decoder 1500 of FIG. 10, the DCT upsampler 900 receives a base layer frame reconstructed by the base layer decoder 400 as an input In₁ to perform upsampling and transmits the upsampled result to a first adder 525.

The first adder 525 adds a residual frame signal output from an IDCT unit 530 to the signal provided by the DCT upsampler 900 in order to reconstruct a residual frame signal that is then fed into a second adder 515. The second adder 515 adds the reconstructed residual frame signal to a signal received from a motion compensator 550, thereby reconstructing an enhancement layer frame.

Since the remaining elements in the video decoder 2500 perform the same operations as their counterparts in the video decoder 1500 of FIG. 10, detailed description will be omitted.

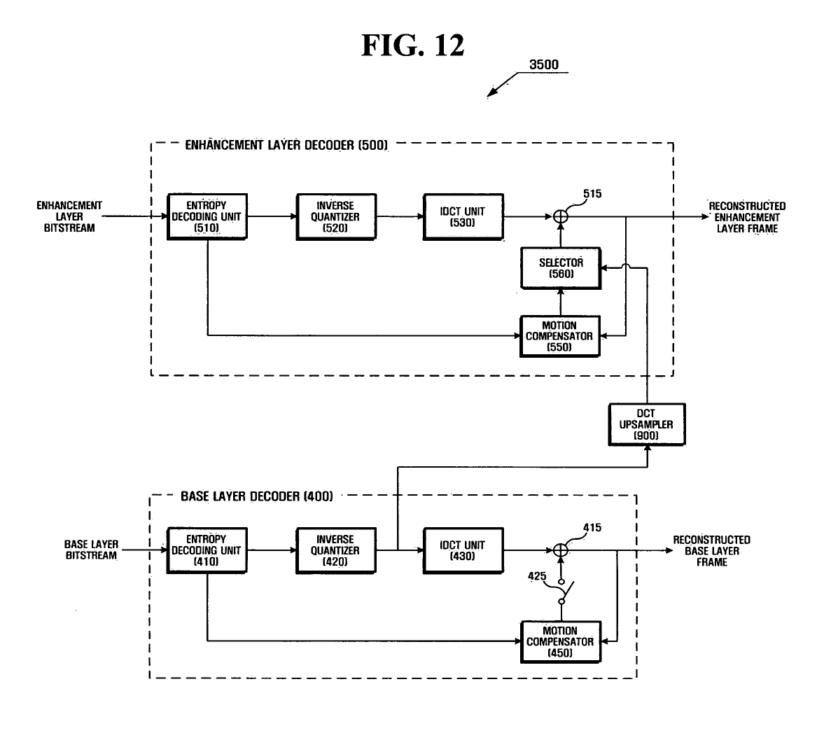

FIG. 12 is a block diagram of a video decoder 3500 corresponding to the video encoder 3000 of FIG. 9. Referring to FIG. 12, the video decoder 3500 mainly includes a DCT upsampler 900, an enhancement layer decoder 500, and a base layer decoder 400.

Unlike in the video decoder 1500 of FIG. 10, the DCT upsampler 900 receives a signal output from an inverse quantizer 420 to perform DCT upsampling. In this case, the DCT upsampler 900 receives an input In₂ (see FIG. 7) as the signal to perform zero padding by skipping a DCT process.

A zero padding unit 920 fills the upper left corner of a block enlarged by the ratio of the resolution of an enhancement layer to the resolution of a base layer with coefficients of a predetermined block received from the inverse quantizer 420 while padding zeros to the remaining region of the enlarged block. An IDCT unit 930 performs IDCT on the enlarged block generated using the zero padding according to the transform size equal to the size of the enlarged block. The inversely DCT-transformed result is then provided to a selector 560 of the enhancement layer decoder 500. For subsequent operations, the enhancement layer decoder 500 performs the same processes as its counterpart shown in FIG. 10, and thus their description will be omitted.

In the exemplary embodiment shown in FIG. 12, because a reconstructed base layer frame has not previously undergone temporal prediction, a motion compensation process by a motion compensator 450 is not needed for reconstruction so a switch 425 is opened.

In FIGS. 6 through 12, various functional components mean, but are not limited to, software or hardware components, such as a Field Programmable Gate Arrays (FPGAs) or Application Specific Integrated Circuits (ASICs), which perform certain tasks. The components may advantageously be configured to reside on the addressable storage media and configured to execute on one or more processors. The functionality provided for in the components and modules may be combined into fewer components and modules or further separated into additional components and modules.

When a base layer region is upsampled for prediction of an enhancement layer, the present invention can preserve low-pass component of the base layer region as much as possible.

The present invention can reduce a mismatch between the result of performing DCT and the result of upsampling a base layer when the DCT is used to perform spatial transform on an enhancement layer.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

What is claimed is:

1. A method for encoding a multi-layer video comprising:
encoding and reconstructing a base layer frame;
performing discrete cosine transform (DCT) upsampling on a second block of a predetermined size in the reconstructed frame corresponding to a first block in an enhancement layer frame;
calculating a difference between the first block and a third block generated by the performing of the DCT upsampling; and
encoding the difference.

2. The method of claim 1, wherein the predetermined size is equal to a transform size of DCT in the base layer frame.

3. The method of claim 1, wherein the size is equal to the size of a motion block used in motion estimation on the base layer frame

4. The method of claim 1, wherein the performing of the DCT upsampling comprises:
performing DCT on the second block according to a transform size equal to a size of the second block;
adding zero padding to a fourth block consisting of DCT coefficients created as a result of the DCT and generating the third block having a size which is enlarged by a ratio of a resolution of an enhancement layer to a resolution of a base layer; and
performing inverse DCT on the third block according to a transform size equal to the size of the third block.

5. The method of claim 1, wherein a DCT downsampler is used to perform downsampling before the encoding of the base layer frame.

6. The method of claim 1, wherein the encoding of the difference comprises:
performing DCT of predetermined transform size on the difference to create DCT coefficients;
quantizing the DCT coefficients to produce quantization coefficients; and
performing lossless encoding on the quantization coefficients.

7. A method for encoding a multi-layer video comprising:
reconstructing a base layer residual frame from an encoded base layer frame;
performing discrete cosine transform (DCT) upsampling on a second block of a predetermined size in the reconstructed base layer residual frame corresponding to a first residual block in an enhancement layer residual frame;
calculating a difference between the first residual block and a third block generated by the DCT upsampling; and
encoding the difference.

8. The method of claim 7, wherein the predetermined size is equal to a transform size of DCT in the base layer frame.

9. The method of claim 7, wherein the performing of the DCT upsampling comprises:
performing DCT on the second block according to a transform size equal to a size of the second block;
adding zero padding to a fourth block consisting of DCT coefficients created as a result of the DCT and generating the third block having a size which is enlarged by a ratio of a resolution of an enhancement layer to a resolution of a base layer; and
performing inverse DCT on the third block according to a transform size equal to the size of the third block.

10. The method of claim 7, wherein the encoding of the difference comprises:
performing DCT of predetermined transform size on the difference to create DCT coefficients;
quantizing the DCT coefficients to produce quantization coefficients; and
performing lossless encoding on the quantization coefficients.

11. A method for encoding a multi-layer video comprising:
encoding and inversely quantizing a base layer frame;
performing discrete cosine transform (DCT) upsampling on a second block in the inversely quantized frame corresponding to a first block in an enhancement layer frame;
calculating a difference between the first block and a third block generated by the DCT upsampling; and
encoding the difference.

12. The method of claim 11, wherein the performing of the DCT upsampling comprises:
performing DCT on the second block according to a transform size equal to a size of the second block;
adding zero padding to a fourth block consisting of DCT coefficients created as a result of the DCT and generating the third block having a size which is enlarged by a ratio of a resolution of an enhancement layer to a resolution of a base layer; and
performing inverse DCT on the third block according to a transform size equal to the size of the third block.

13. The method of claim 11, wherein the encoding of the difference comprises:
performing DCT of predetermined transform size on the difference to create DCT coefficients;
quantizing the DCT coefficients to produce quantization coefficients; and
performing lossless encoding on the quantization coefficients.

14. A method for decoding a multi-layer video comprising:
reconstructing a base layer frame from a base layer bitstream;
reconstructing a difference frame from an enhancement layer bitstream;
performing discrete cosine transform (DCT) upsampling on a second block of a predetermined size in the reconstructed base layer frame corresponding to a first block in the difference frame; and
adding a third block generated by the DCT upsampling to the first block.

15. A method for decoding a multi-layer video comprising:
reconstructing a base layer frame from a base layer bitstream;
reconstructing a difference frame from an enhancement layer bitstream;
performing discrete cosine transform (DCT) upsampling on a second block of a predetermined size in the reconstructed base layer frame corresponding to a first block in the difference frame;
adding a third block generated by the DCT upsampling to the first block; and
adding a fourth block generated by adding the third block to the first block to a block in a motion-compensated frame corresponding to the fourth block.

16. A method for decoding a multi-layer video comprising:
extracting texture data from a base layer bitstream and inversely quantizing the extracted texture data;
reconstructing a difference frame from an enhancement layer bitstream;
performing discrete cosine transform (DCT) upsampling on a second block of a predetermined size in the inversely quantized result corresponding to a first block in the difference frame; and
adding a third block generated by the DCT upsampling to the first block.

17. A multi-layered video encoder comprising:
means for encoding and reconstructing a base layer frame;
means for performing discrete cosine transform (DCT) upsampling on a
second block of a predetermined size in the reconstructed frame corresponding to a first block in an enhancement layer frame;
means for calculating a difference between the first block and a third block generated by the DCT upsampling; and
means for encoding the difference.

18. A multi-layered video decoder comprising:
means for reconstructing a base layer frame from a base layer bitstream;
means for reconstructing a difference frame from an enhancement layer bitstream;
means for performing discrete cosine transform (DCT) upsampling on a second block of a predetermined size in the reconstructed base layer frame corresponding to a first block in the difference frame; and
means for adding a third block generated by the DCT upsampling to the first block.
